(19) United States
(12) Patent Application Publication
(10) Pub. No.: US 2003/0187957 A1
(43) Pub. Date: Oct. 2, 2003

(54) Automatic data download system and method

(76) Inventors: Tong Huang, Shenzhen (CN); Xiumin Duan, Shenzhen (CN); Caiyang Luo, Shenzhen (CN); Chung-I Lee, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/158,740

(22) Filed: May 29, 2002

(30) Foreign Application Priority Data
Mar. 29, 2002 (TW) 91106439

(51) Int. Cl. G06F 15/16

(52) U.S. Cl. 709/219

(57) ABSTRACT

An automatic data download system and method for downloading data from a remote server (3) to a local database (20) via a communications network (8). The automatic data download system checks the local database before downloading required data from the remote server, and downloads only the data that are not stored in the local database. The automatic data download system includes a data check unit (11) installed in a client computer (1) which is electronically connected with the local database for checking data stored in the local database against data required to be downloaded; a data download unit (12) installed in the client computer for automatically downloading data that are required to be downloaded and that are not already stored in the local database; and a recording unit (13) installed in the client computer for recording data still not downloaded or not successfully downloaded.

### BACKGROUND OF THE INVENTION

1. Field of the Invention

This invention relates to systems and methods for automatically downloading data from remote servers via a communications network, and more particularly to systems and methods that can automatically download data from remote servers to local databases.

2. Description of Prior Art

As web communications technology advances, more and more web information and service suppliers are providing users with data search and data download capability via networks. Users can transmit data to the suppliers via the networks, and directly download data from remote servers of the suppliers.

When users search for required data via the networks, most web sites have a link for data search. A user can set up a search query, and list all required data titles in the search query. The user then clicks on one of the titles or a related link on a web page, to get a display of and/or download data relating to the title from a remote server supporting the web site. Generally, an information-providing web site provides a download function which allows users to download the data of only one title at a time, by clicking on the relevant link on the web page. If a user wants to download all data of multiple titles in a search query, he must manually download the data of each title one by one. When the required data comprise a large number of titles, this is exceedingly time-consuming. For instance, some data are stored in databases in the format of image files which must be downloaded one page at a time. In addition, if the network is temporarily blocked or experiences other difficulties, the data download procedure becomes more complicated and inefficient.

When searching and downloading data from the networks, multiple users in a same organization can cooperate as a group. The group accesses the networks via a common server of the organization that can store the data downloaded. The users in the group visit the common server via an intranet, and can retrieve data from and send data to the common server. The users in the group may deal with similar work of the organization, and thus need and use some common data. However, when an individual user downloads required data via the networks, the user may not know about the requirements of other users in the group. Therefore, identical data may be downloaded more than one time when it is required by more than one user in the group. This is unduly time-consuming and inefficient.

U.S. Pat. No. 6,339,785 discloses a data download system that can concurrently download a file from a plurality of remote servers. As shown in FIG. 7, a client computer 30 can download data from a plurality of remote servers 51, 52, 53 via a communications network 40. The data download system can concurrently download a part of the file from each remote server and integrate the parts of the file into the single complete file in the client computer 30.

However, this data download system cannot prevent repeated downloading of data that are already stored in a local database of the client computer 30, and further cannot re-download any data that are not successfully downloaded a first time.

Accordingly, what is needed is a system and method which can overcome the abovementioned problems.

### SUMMARY OF THE INVENTION

A primary object of the present invention is to provide a system which automatically downloads data via a communications network according to a search query set up by a user, and which prevents repeated downloading of data that are already stored in a local database of the user.

Another object of the present invention is to provide a method which provides automatic downloading of data via a communications network according to a search query set up by a user, and which prevents repeated downloading of data that are already stored in a local database of the user.

In one aspect of the present invention, an automatic data download system for downloading data from a remote server to a local database via a communications network comprises a local database; a data check unit installed in a client computer which is electronically connected with the local database for checking data stored in the local database against data required to be downloaded; a data download unit installed in the client computer for automatically downloading data that are required to be downloaded and that are not already stored in the local database; and a recording unit installed in the client computer for recording data still not downloaded or not successfully downloaded. The automatic data download system checks the local database before downloading required data from the remote server, and downloads only the data that are not stored in the local database.

In another aspect of the present invention, an automatic data download method for downloading data from a remote server to a local database via a communications network comprises the steps of: (a) downloading a title list of required data from the remote server to a log according to a download requirement set up by a user; (b) checking the title list of the log against data stored in the local database; (c) deleting from the log all titles whose data are already stored in the local database; (d) retrieving a title from the title list of the log; (e) downloading data of the title from the remote server to the local database; (f) deleting the title from the title list after the data of the title are successfully downloaded; (g) repeating steps (d) through (f) until a last title in the title list is retrieved and its data successfully downloaded; and (h) re-downloading any data that are not successfully downloaded.

### BRIEF DESCRIPTION OF THE DRAWINGS

FIG. 1 is a schematic diagram of basic hardware infrastructure of an automatic data download system according to a preferred embodiment of the present invention;

FIG. 2 is a schematic diagram of a framework of the automatic data download system shown in FIG. 1;

FIG. 3 is a schematic diagram of a framework of the automatic data download system according to an alternative embodiment of the present invention;

FIG. 4 is a flowchart of operation of the automatic data download system according to the preferred embodiment of the present invention;

FIG. 5 is a detailed flowchart of a designated step 302 shown in the flowchart of FIG. 4;

FIG. 6 is a detailed flowchart of data downloading procedure according to the preferred embodiment of the present invention; and

FIG. 7 is a schematic diagram of a conventional system for downloading data from remote servers.

### DETAILED DESCRIPTION OF THE INVENTION

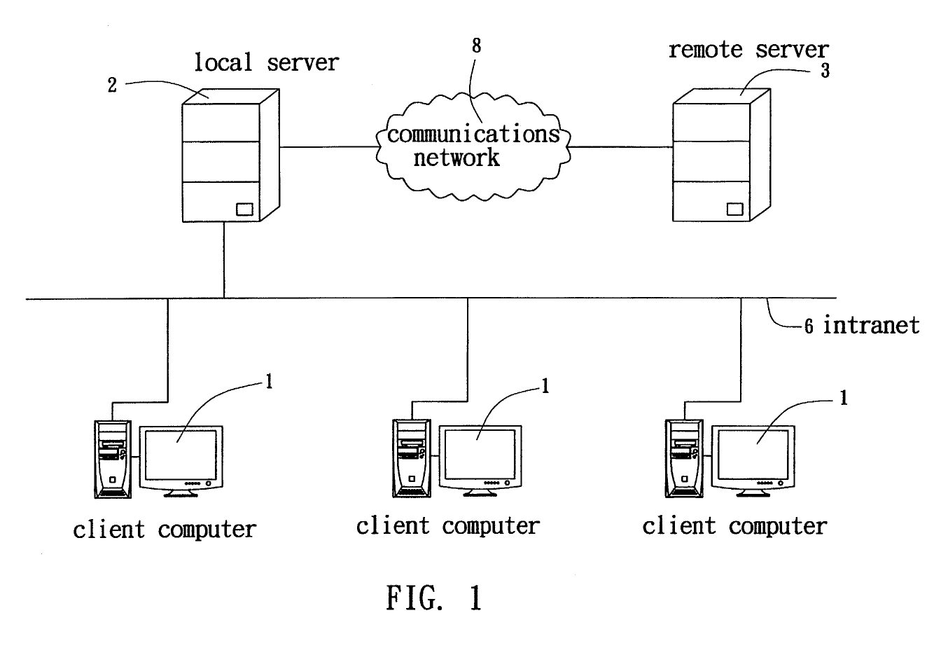

FIG. 1 is a schematic diagram of basic hardware infrastructure of an automatic data download system according to a preferred embodiment of the present invention. The automatic data download system is implemented in a client/server model which includes a plurality of client computers 1 and a local server 2. An intranet 6 is provided to connect the client computers 1 and the local server 2 and enable data interchange therebetween. The local server 2 can electronically visit a remote server 3 and retrieve data therefrom via a communications network 8. The remote server 3 can be any server which connects to the communications network 8 and is available for access by the local server 2. The communications network 8 can be the Internet or another suitable Transfer Control Protocol/Internet Protocol (TCP/IP) based network that implements hypertext transfer protocol (HTTP) and file transfer protocol (FTP).

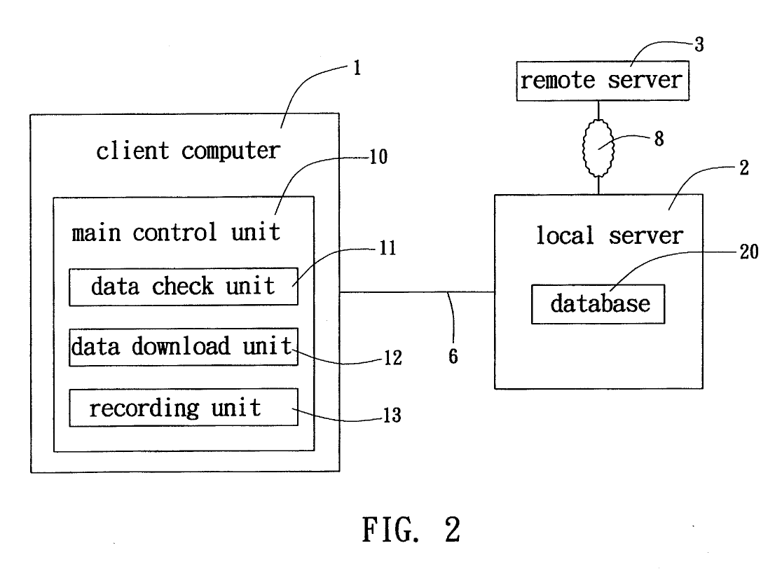

FIG. 2 is a schematic diagram of a framework of the automatic data download system shown in FIG. 1. Each client computer 1 comprises a main control unit 10 for implementing the automatic data download system. The main control unit 10 comprises a data check unit 11 for searching the local server 2 for data required to be downloaded, a data download unit 12 for downloading the data via the communications network 8, and a recording unit 13 for recording data still not downloaded or not successfully downloaded. The client computer 1 is connected with the local server 2 via the intranet 6, and the local server 2 comprises a database 20 for storing data downloaded. The local server 2 can download required data from the remote server 3 via the communications network 8. Through the local server 2, the client computer 1 can also electronically visit the remote server 3 via the communications network 8. When downloading data from the remote server 3, the data check unit 11 in the main control unit 10 firstly searches the database 20 in the local server 2 to ascertain if all the data required are already stored in the database 20. If the database 20 does not have all the required data, the data download unit 12 automatically retrieves the required data not stored in the database 20 from the remote server 3 and stores such data in the database 20. Before and during the process of downloading, the recording unit 13 records all required data still not downloaded or not successfully downloaded. The data download unit 12 automatically downloads or re-downloads such data recorded by the recording unit 13.

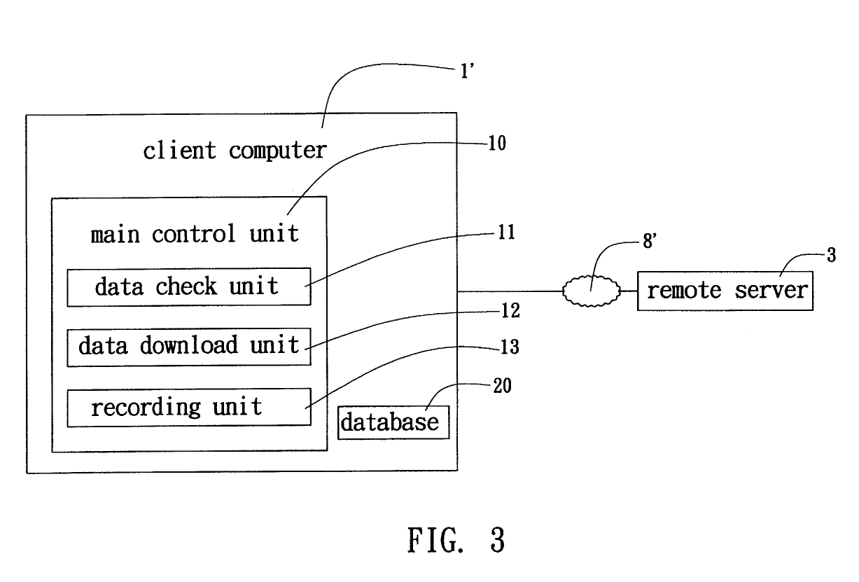

FIG. 3 is a schematic diagram of a framework of the automatic data download system according to an alternative embodiment of the present invention. The database 20 is installed in a client computer 1′, and the client computer 1′ directly visits the remote server 3 via a communications network 8′. The data check unit 11 in the main control unit 10 firstly searches the database 20 in the local server 2 to ascertain if the data required are already stored in the database 20. If the database 20 does not have all the required data, the data download unit 12 automatically retrieves the required data not stored in the database 20 from the remote server 3 and stores such data in the database 20. Before and during the process of downloading, the recording unit 13 records all required data still not downloaded or not successfully downloaded. The data download unit 12 automatically downloads or re-downloads such data recorded by the recording unit 13.

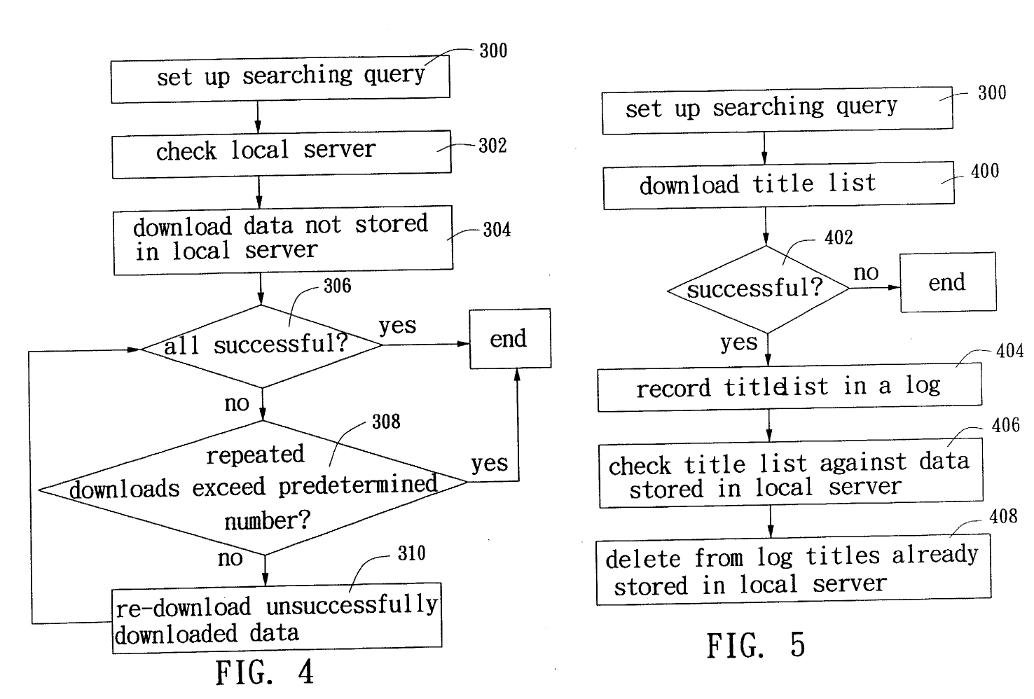

FIG. 4 is a flowchart of operation of the automatic data download system according to the preferred embodiment of the present invention. In step 300, a user firstly sets up a searching query according to the user's download requirements. The searching query includes the address of the remote server 3 on the communications network 8, a key word, and a time span. In step 302, the data check unit 11 checks the data stored in the database 20 in the local server 2 against the data required according to the searching query. In step 304, the data download unit 12 automatically downloads the data defined by the searching query and not stored in the database 20. In step 306, the automatic data download system checks if all the data required to be downloaded are downloaded successfully. If all such data are downloaded successfully, then the data download process is ended. If any such data are not downloaded successfully, then in step 308, the automatic data download system checks if such unsuccessfully downloaded data has been repeatedly downloaded in excess of a predetermined number of times. The predetermined number may, for example, be three. If the unsuccessfully downloaded data have been repeatedly downloaded in excess of the predetermined number of times, then the data download process is ended. If the unsuccessfully downloaded data have not been repeatedly downloaded in excess of the predetermined number of times, then in step 310, the unsuccessfully downloaded data are re-downloaded. Thereupon, operation of the automatic data download system returns to step 306. From step 306, operation continues another cycle similar to that described above until all the remaining unsuccessfully downloaded data are successfully downloaded or until the remaining unsuccessfully downloaded data have been repeatedly downloaded in excess of the predetermined number of times.

FIG. 5 is a detailed flowchart of step 302 as described above in relation to the flowchart of FIG. 4; that is, of the data check unit 11 checking the data stored in the database 20 in the local server 2 against the data required according to the searching query. In step 300, the searching query is set up as described above. Then in step 400, the data download unit 12 downloads a title list showing all the titles of the data that correspond to the searching query. In step 402, the automatic data download system checks if the title list is downloaded successfully. If the title list is not downloaded successfully, then the data download process is ended. If the title list is downloaded successfully, then in step 404 the title list is recorded in a log. In step 406, the data check unit 11 automatically checks the titles in the title list against the data stored in the database 20 in the local server 2. If there are data in the database 20 with identical titles as recorded in the title list, then in step 408 the identical titles are deleted from the log. Therefore, what remains in the log is a title list comprising titles whose data are not already stored in the local server 2.

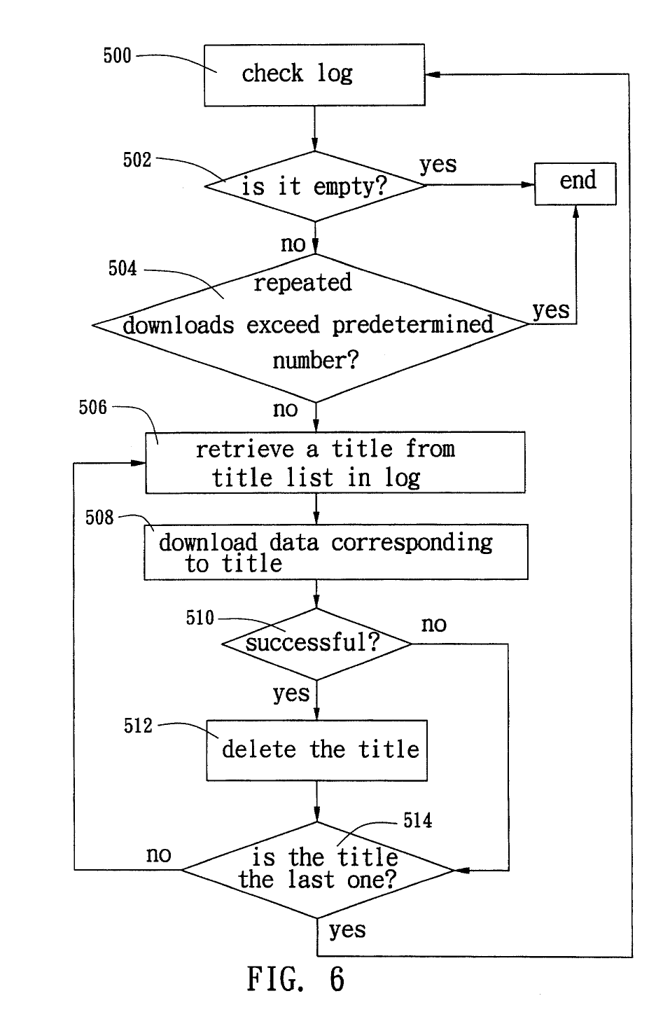

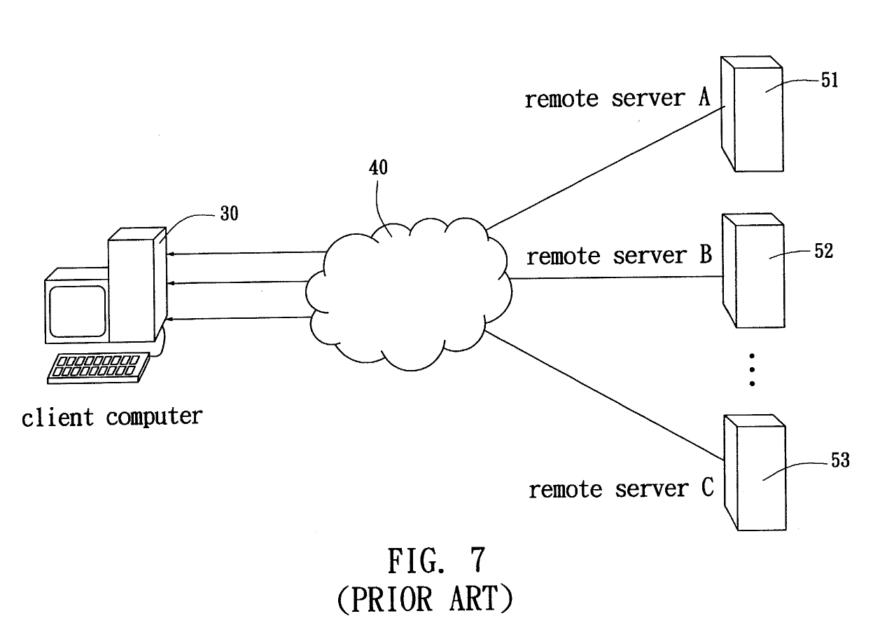

FIG. 6 is a detailed flowchart of data downloading procedure according to the preferred embodiment of the present invention. In step 500, the data download unit 12 firstly checks the log to see if the log is empty. If the log is empty, the procedure is ended. If the log is not empty, then in step 504, the data download unit 12 checks if the data have been repeatedly downloaded in excess of the predetermined number of times. If the data have been repeatedly downloaded in excess of the predetermined number of times, the procedure is ended. If the data have not been repeatedly downloaded in excess of the predetermined number of times, then in step 506, the data download unit 12 retrieves a title from the title list in the log. In step 508, the data download unit 12 downloads data corresponding to the title from the remote server 3. The downloaded data are stored in the database 20 in the local server 2. In step 510, the data download unit 12 checks if the downloaded data are downloaded successfully. If the downloaded data are downloaded successfully, then in step 512 the title is deleted from the title list in the log and the procedure continues to step 514. If the downloaded data are not downloaded successfully, the procedure continues directly to step 514. In step 514, the data download unit 12 checks if the title is the last title in the title list. If the title is not the last title in the title list, the procedure returns to step 506. From step 506, the procedure continues another cycle similar to that described above until the last title is retrieved from the title list in the log. If/when the title is the last title in the title list, the procedure returns to step 500. From step 500, the procedure continues another cycle similar to that described above until the log is empty or the required data have been repeatedly downloaded in excess of the predetermined number of times.

The preferred embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. An automatic data download system, comprising:
a local database;
a data check unit installed in a client computer which is electronically connected with the local database for checking data stored in the local database against data required to be downloaded; and
a data download unit installed in the client computer for automatically downloading data that are required to be downloaded and that are not already stored in the local database.

2. The system as claimed in claim 1, further comprising a recording unit installed in the client computer for recording data still not downloaded or not successfully downloaded.

3. The system as claimed in claim 1, wherein the local database is installed in the client computer.

4. The system as claimed in claim 1, wherein the local database is installed in a local server that is connected with the client computer via an electronic communications network.

5. The system as claimed in claim 4, wherein the electronic communications network comprises an intranet.

6. An automatic data download method for downloading data from a remote server to a local database via a communications network, the method comprising the steps of:
downloading a title list of required data from the remote server to a log according to a download requirement set up by a user;
checking the title list of the log against data stored in the local database; and
downloading data of titles recorded in the title list of the log from the remote server to the local database, wherein said data are not already stored in the local database.

7. The method as claimed in claim 6, further comprising the step of:
deleting from the title list of the log all titles whose data are already stored in the local database.

8. The method as claimed in claim 6, wherein the step of downloading data of titles recorded in the title list of the log from the remote server to the local database comprises the steps of:
retrieving a title from the title list of the log;
downloading data of the title from the remote server to the local database; and
deleting the title from the title list of the log after the data of the title are successfully downloaded.

9. The method as claimed in claim 6, further comprising the step of:
re-downloading any of said data that are not successfully downloaded.

10. An automatic data download method for downloading data from a remote server to a local database via a communications network, the method comprising the steps of:
downloading a title list of required data from the remote server to a log according to a download requirement set up by a user;
checking the title list of the log against data stored in the local database;
deleting from the title list of the log all titles whose data are already stored in the local database; and
downloading data of titles recorded in the title list from the remote server to the local database, wherein said data are not already stored in the local database.

11. The method as claimed in claim 10, wherein the step of downloading data of titles recorded in the title list from the remote server to the local database comprises the steps of:
retrieving a title from the title list of the log;
downloading data of the title from the remote server to the local database; and
deleting the title from the title list of the log after the data of the title are successfully downloaded.

12. The method as claimed in claim 10, further comprising the step of:
re-downloading any of said data that are not successfully downloaded.

13. An automatic data download method for downloading data from a remote server to a local database via a communications network, the method comprising the steps of:
(a) downloading a title list of required data from the remote server to a log according to a download requirement set up by a user;
(b) checking the title list of the log against data stored in the local database;
(c) deleting from the title list of the log all titles whose data are already stored in the local database;
(d) retrieving a title from the title list of the log;
(e) downloading data of the title from the remote server to the local database;
(f) deleting the title from the title list of the log after the data of the title are successfully downloaded;
(g) repeating steps (d) through (f) until a last title in the title list is retrieved and its data successfully downloaded; and
(h) re-downloading any data that are not successfully downloaded.
